(19) United States
(12) Patent Application Publication
(10) Pub. No.: US 2011/0105195 A1
(43) Pub. Date: May 5, 2011

(54) METHOD FOR PROCESSING INCOMING CALL AND COMMUNICATION DEVICE USING THE SAME

(75) Inventor: LUNG DAI, Tu-Cheng (TW)

(73) Assignee: HON HAI PRECISION INDUSTRY CO., LTD., Tu-Cheng (TW)

(21) Appl. No.: 12/760,433

(22) Filed: Apr. 14, 2010

(30) Foreign Application Priority Data
Oct. 30, 2009 (CN) 200910309060.0

(51) Int. Cl. H04B 1/38

(52) U.S. Cl. 455/567

(57) ABSTRACT

A method for processing an incoming call implemented by a first communication device is provided. The method includes: determining whether the first communication device is receiving an incoming call from a second communication device; if the first communication device is receiving the incoming call from the second communication device, determining whether the first communication device is in silent mode; and if the first communication device is in silent mode, transmitting outgoing information to the second communication device, such that a user of the second communication device knows that the first communication device is in silent mode.

### BACKGROUND

1. Technical Field

The present disclosure relates to communication technologies, and particularly to a method for processing an incoming call.

2. Description of Related Art

In certain situations, a person may place his/her cell phone in silent mode so they will not be disturbed. Hence, when another person dials that cell phone number while it is silent mode, the cell phone will not ring.

However, the caller may make the mistake that the callee is screening the call and does not want to answer his/her call, in some cases this may invoke misunderstanding between the caller and the callee.

Therefore, improved methods for processing an incoming call and communication devices using the methods are desired.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of a communication system in accordance with an exemplary embodiment.

FIG. 2 is a block diagram of a first communication device of FIG. 1 in accordance with an exemplary embodiment.

FIG. 3 is a flowchart of a method for processing an incoming call in accordance with an exemplary embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

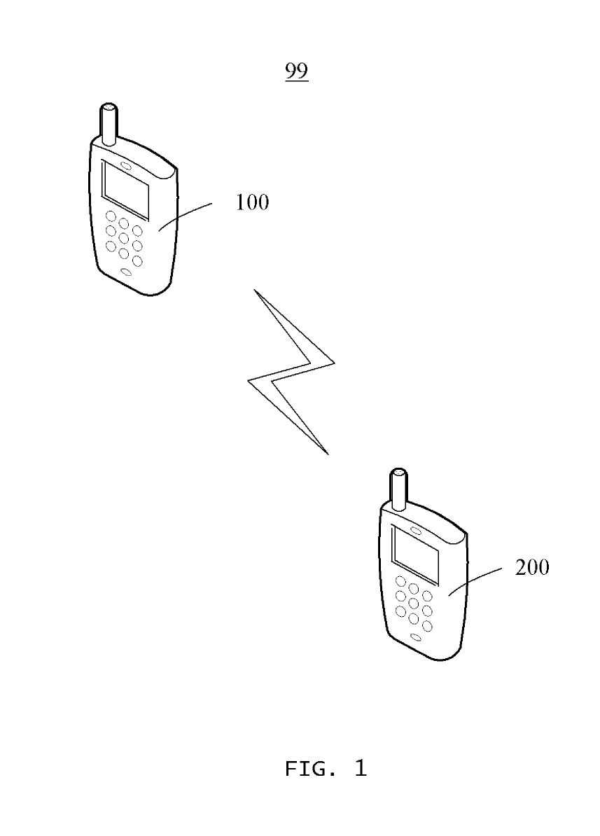

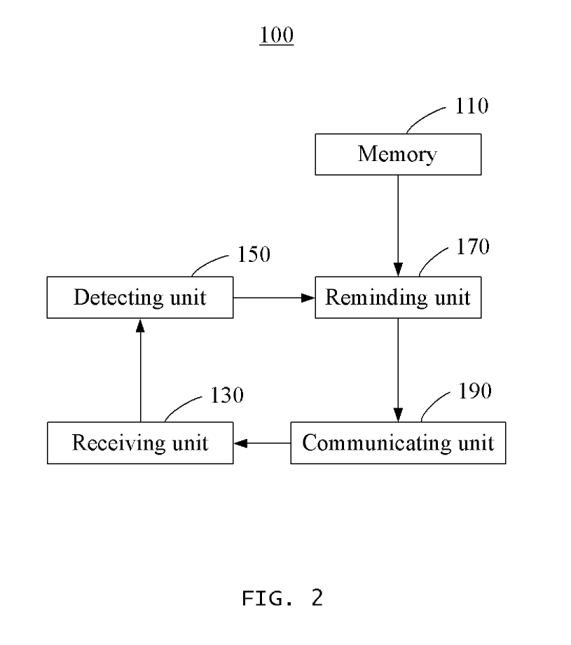

Referring to FIGS. 1 and 2, a communication system 99 includes a first communication device 100 and a second communication device 200 capable of communicating with the first communication device 100. The first and second communication devices 100 and 200 may be cell phones, or personal digital assistants (PDAs) with communication functions.

The first communication device 100 includes a communication unit 190, a memory 110, a receiving unit 130, a detecting unit 150, and a reminding unit 170.

The communicating unit 190 is used for communicating with the second communication device 200 to establish a connection between the first communication device 100 and the second communication device 200. Information is transmitted between the first communication device 100 and the second communication device 200 via the connection. The transmitted information may be audio information or textual information.

The memory 110 is used for storing outgoing information. The outgoing information is used for reminding a first user of the second communication device 200 that the first communication device 100 is in silent mode.

The receiving unit 130 is used for receiving an incoming call from the second communication device 200 via the connection, and generating a reminding signal when receiving the incoming call from the second communication device 200.

The detecting unit 150 is used for detecting whether the first communication device 100 is in silent mode in response to the reminding signal, and generating a detecting signal when the first communication device 100 is in silent mode. As used herein and hereinafter, the “silent mode” may mean that the first communication device 100 does not emit any sounds in response to an incoming call. It is noteworthy that the “silent mode” might be interpreted to include a vibration mode. “Vibration mode” means that the first communication device 100 vibrates in response to an incoming call.

The reminding unit 170 is used for invoking the outgoing information from the memory 110 in response to the detecting signal, and transmitting the outgoing information to the second communication device 200, such that the first user of the second communication device 200 knows that the first communication device 100 is in silent mode. Thus the first user will be aware that a second user of the first communication device 100 may not be able to answer his/her call, thus a misunderstanding is not generated between the first user and the second user.

In the embodiment, the outgoing information may be a ringtone that the first communication device 100 responds to the second communication device 200. The outgoing information may be audio information. For example, the first communication device 100 pre-records audio information “The called cell phone is in silent mode”. In addition, the outgoing information may be textual information, and transmitted to the second communication device 200 in the form of a short message.

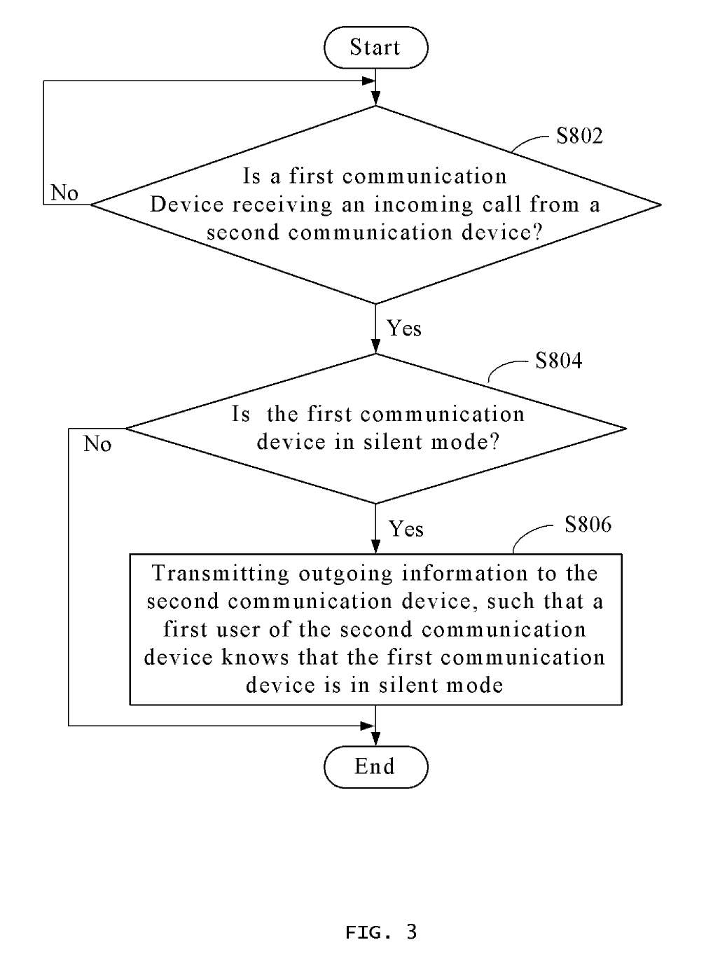

Referring to FIGS. 1 and 3, a method for processing an incoming call is provided. The method may be implemented by a first communication device 100 in the form of program codes or instructions. The first communication device 100 may be a cell phone, or a personal digital assistant (PDA) with communication functions. When receiving the incoming call from a second communication device 200, the first communication device 100 executes the program codes or instructions to implement the method. The method includes the following steps.

In step S802, determining whether a first communication device 100 is receiving an incoming call from a second communication device 200. If the first communication device 100 is determined to be receiving the incoming call from the second communication device 200, step S804 is implemented. If the first communication device 100 is determined not to be receiving the incoming call from the second communication device 200, step S802 is implemented again.

In step S804, determining whether the first communication device 100 is in silent mode. If the first communication device 100 is determined to be in silent mode, step S806 is implemented. If the first communication device 100 is determined not to be in silent mode, the procedure is finished.

In step S806, transmitting outgoing information to the second communication device 200, such that a first user of the second communication device 200 knows that the first communication device 100 is in silent mode. Thus the first user will be aware that a second user of the first communication device 100 may not be able to answer his/her call, thus a misunderstanding is not generated between the first user and the second user.

In the embodiment, the outgoing information may be a ringtone that the first communication device 100 responds to the second communication device 200. The outgoing information may be audio information. For example, the first communication device 100 can pre-record audio information “The called cell phone is in silent mode”. In addition, the outgoing information may be textual information, and transmitted to the second communication device 200 in the form of a short message.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A method for processing an incoming call used by a first communication device, the method comprising:
determining whether the first communication device is receiving an incoming call from a second communication device;
if the first communication device is determined to be receiving the incoming call from the second communication device, determining whether the first communication device is in silent mode; and
if the first communication device is determined to be in silent mode, transmitting outgoing information to the second communication device, such that a user of the second communication device knows that the first communication device is in silent mode.

2. The method according to claim 1, further comprising:
if the first communication device is determined not to be receiving the incoming call from the second communication device, repeating determining whether the first communication device is receiving the incoming call from the second communication device.

3. The method according to claim 1, wherein the outgoing information is a ringtone that the first communication device responds to the second communication device.

4. The method according to claim 1, wherein the outgoing information is audio information, and the outgoing information is pre-recorded by the first communication device.

5. The method according to claim 1, wherein the outgoing information is textual information, and the outgoing information is transmitted to the second communication device in the form of a short message.

6. A communicating device, comprising:
a communicating unit communicating with another communication device to establish a connection between the communication device and the another communication device;
a memory for storing outgoing information, the outgoing information being for reminding a user of the another communication device that the first communication device is in silent mode;
a receiving unit for receiving an incoming call from the another communication device via the connection, and generating a reminding signal when receiving the incoming call from the another communication device;
a detecting unit detecting whether the communication device is in silent mode in response to the reminding signal, and generating a detecting signal when the communication device is in silent mode; and
a reminding unit invoking the outgoing information from the memory responding to the detecting signal, and transmitting the outgoing information to the another communication device, such that the user of the another communication device knows that the communication device is in silent mode.

7. The communication device according to claim 6, wherein the outgoing information is a ringtone that the communication device responds to the another communication device.

8. The communication device according to claim 6, wherein the outgoing information is audio information, and the outgoing information is pre-recorded by the communication device.

9. The communication device according to claim 6, wherein the outgoing information is textual information, and the outgoing information is transmitted to the another communication device in the form of a short message.

10. A communication device, comprising:
a receiving unit capable of receiving an incoming call from another communication device; and generating a reminding signal when receiving the incoming call from the another communication device; and
a reminding unit transmitting outgoing information to the another communication device responding to the reminding signal such that a user of the another communication device knows that the communication device is in silent mode when the communication device is in silent mode.

11. The communication device according to claim 10, further comprising:
a memory for storing the outgoing information; and
a detecting unit detecting whether the communication device is in silent mode in response to the reminding signal, and generating a detecting signal when the communication device is in silent mode;
wherein the reminding unit transmits the outgoing information to the another communication device responding to the detecting signal.

12. The communication device according to claim 10, wherein the outgoing information is a ringtone that the communication device responds to the another communication device.

13. The communication device according to claim 10, wherein the outgoing information is audio information, and the outgoing information is pre-recorded by the communication device.

14. The communication device according to claim 10, wherein the outgoing information is textual information, and the outgoing information is transmitted to the another communication device in the form of a short message.
